(19) United States
(12) Patent Application Publication
(10) Pub. No.: US 2003/0014892 A1
(43) Pub. Date: Jan. 23, 2003

(54) Protective display holders

(75) Inventor: Shawn Y. Matsuda, South Gate, CA (US)

Correspondence Address: David Weiss, Law Offices of David Weiss, 12650 Riverside Drive, Suite 100, North Hollywood, CA, 91607-3492, US

(73) Assignee: Rembrandt Photo Services, a California Corporation

(21) Appl. No.: 09/910,377

(22) Filed: Jul. 19, 2001

(51) Int. Cl. G09F 3/18

(52) U.S. Cl. 40/661

(57) ABSTRACT

Rigid holders for protectively displaying collectible items such as sports and game cards, photographs, comic books and coins. The holder is constructed of three rigid panels, specifically a rear panel, a front panel, and an intermediate panel including an opening therethrough and secured between the rear and front panels. The dimensions of the opening are equal to or greater than the dimensions of the collectible item, and the thickness of the intermediate panel is equal to or greater than the thickness of the collectible item. The collectible item is contained within the opening in the intermediate panel and between the rear and front panels when the three panels are secured together by fasteners.

### BACKGROUND OF THE INVENTION

This invention relates to rigid holders for protectively displaying collectible items, and in particular for protectively displaying generally flat collectible items such as sports and game cards, photographs, comic books and coins.

Various holders are readily available for protecting and displaying sports or trading cards and photographs. One such type of prior art holders, commonly referred to as screw-down holders, comprises transparent rigid bottom and top plates or panels secured together by four screw fasteners, with the card or photograph held between flat surfaces of the two panels. The bottom panel may include a rectangular recess of depth slightly greater than the thickness of the card or photograph and into which the card or photograph is placed before the top panel is secured to the bottom panel.

### SUMMARY OF THE INVENTION

The present invention generally provides a holder that is constructed of three rigid panels instead of two as in the prior art. The holder includes a bottom or rear panel, a top or front panel, and an intermediate panel including an opening therethrough, with the intermediate panel secured between the rear and front panels. The dimensions of the opening are equal to or greater than the dimensions of the collectible item, and the thickness of the intermediate panel (and hence the depth of the opening) is equal to or greater than the thickness of the collectible item. The thickness of the intermediate panel may be predetermined for use with collectible items (such as sports cards or game cards, comic books or coins) of a particular thickness or of a range of thicknesses. In addition, several intermediate panels of different thicknesses and different size openings may be interchangeable for use with the same rear and front panels. The front panel is transparent for permitting the contained collectible item to be viewed.

More specifically, the present invention provides a display holder for at least one item having thickness and peripheral dimensions, the holder comprising the combination of: a first rigid panel of predetermined thickness between parallel flat surfaces thereof, the predetermined thickness being equal to or greater than the thickness of the at least one item, the first panel having at least one opening therethrough of dimensions equal to or greater than the peripheral dimensions of the at least one item, the first panel including spaced-apart apertures therethrough; a second rigid panel and a third rigid panel, each of the second and third rigid panels including a flat surface and having peripheral dimensions substantially the same as the peripheral dimensions of the first panel, at least one of the second and third panels being transparent; the panels arranged with the first panel between the second and third panels and with one of the flat surfaces of the first panel contacting the flat surface of the second panel and the other of the flat surfaces of the first panel contacting the flat surface of the third panel, each of the second and third panels including apertures respectively aligned with the apertures of the of first panel; and fasteners removably receivable in the aligned apertures for securing the panels together. With at least one of the collectible items contained within at least one of the openings in the first panel and between the flat surfaces of the second and third panels, the fasteners are caused to be received in the aligned apertures and secure the three panels together.

The intermediate or first panel may be transparent, or it may be opaque, and in either case it may be colored.

In the preferred embodiment, the dimensions of the opening of the first panel are rectangular for accommodating a rectangular item such as a card, a photograph, or a comic book, and the peripheral dimensions of the first, second and third panels are rectangular. Alternatively, the at least one opening of the first panel may be circular for accommodating at least one coin.

### BRIEF DESCRIPTION OF THE DRAWINGS

The novel features believed to be characteristic of the invention, together with further advantages thereof, will be better understood from the following description considered in connection with the accompanying drawings in which preferred embodiments of the present invention are illustrated by way of example. It is to be understood, however, that the drawings are for the purpose of illustration and description only and are not intended as a definition of the limits of the invention.

FIG. 1 is a front perspective view of a protective display holder for a collectible item in accordance with the present invention;

FIG. 2 is a front elevation view of a rear panel included in the embodiment of FIG. 1;

FIG. 3 is a front elevation view of an intermediate panel included in the embodiment of FIG. 1, the dashed lines indicating an example of a collectible item in combination therewith;

FIG. 4 is a front elevation view of a front panel included in the embodiment of FIG. 1;

FIG. 5 is a cross-sectional representation of the rear panel shown in FIG. 2 taken along the line 5-5 in the direction of the appended arrows;

FIG. 6 is a cross-sectional representation of the intermediate panel shown in FIG. 3 taken along the line 6-6 in the direction of the appended arrows, but without the collectible item indicated in FIG. 3;

FIG. 7 is a cross-sectional representation of the front panel shown in FIG. 4 taken along the line 7-7 in the direction of the appended arrows;

FIG. 8 is a cross-sectional representation of the preferred holder embodiment of FIG. 1 taken along the line 8-8 in the direction of the appended arrows, and including a collectible item contained therein;

FIG. 9 is an elevation view of an alternative embodiment of an intermediate panel in accordance with the present invention; and

FIG. 10 is an elevation view of an alternative embodiment of an intermediate panel for accommodating circular items such as coins, the dotted circle representing a coin in combination therewith.

### DETAILED DESCRIPTION OF THE PREFERRED EMBODIMENTS

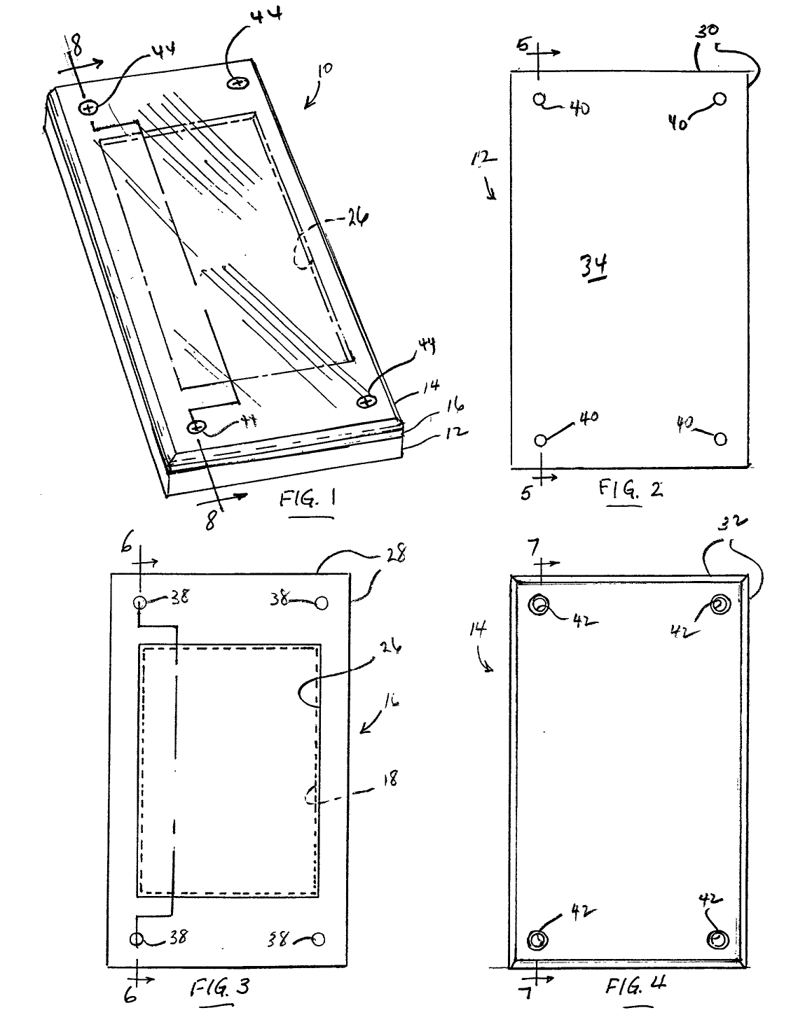

Turning to FIGS. 1-8, the preferred embodiment of the protective display holder 10 is substantially rectangular in configuration and includes a rigid base or rear plate or panel 12, a rigid top or front plate or panel 14, and a rigid intermediate plate or panel 16 positioned between the rear and front panels 12, 14. Each of the panels 12, 14, 16 is preferably of a plastic material such as acrylic or Lucite®; at least the front panel 14 is transparent, and it is preferred that the rear panel 12 be transparent as well.

The intermediate panel 16 is of a predetermined thickness t (see FIGS. 6 and 8) equal to or greater than (preferably slightly greater than) the thickness of the item 18 to be held by the holder 10. The collectible item 18 may be a substantially flat item such as a collectible card (e.g. a sports card or a game card), or a photograph, or a book (e.g. a comic book or other type of book for which protection is desired). Each of these types of collectible items 18 have a thickness (indicated in FIG. 8 by the reference numeral 20) and have outside or peripheral dimensions (indicated by the dashed outline in FIG. 3) typically defining a rectangle. The preferred embodiment 10 of FIGS. 1-8 will be described with the collectible item 18 being a collectible card having thickness and rectangular peripheral dimensions, it being understood that this discussion is applicable as well to other types of collectible items having a thickness and peripheral dimensions.

The thickness t is measured between parallel flat surfaces 22, 24 of the intermediate panel 16, and is equal to or greater than (preferably slightly greater than) the thickness 20 of the collectible card 18. The intermediate panel 16 has an opening 26 therethrough of predetermined peripheral dimensions equal to or greater than (preferably slightly greater than) the peripheral dimensions of the card 18; i.e., for use with the rectangular card 18, the opening 26 is a rectangular opening of width and height preferably slightly greater than the width and height dimensions of the card 18. The opening 26 is preferably approximately centrally situated within the outer or peripheral dimensions 28 of the intermediate panel 16.

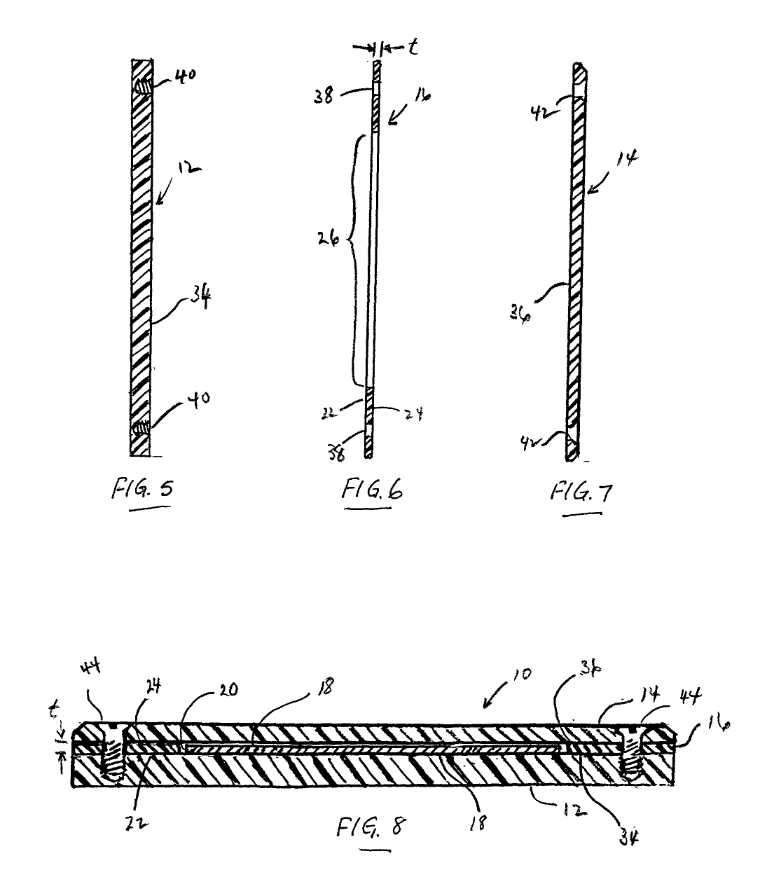

The rear and front panels 12, 14 have outer or peripheral dimensions 30, 32 preferably substantially the same as the peripheral dimensions 28 of the intermediate panel 16, i.e. the three panels 12, 14, 16 define rectangles of the same size in the preferred embodiment. The edges of the front panel 14 may be beveled as shown in FIGS. 4, 7 and 8.

The front face of the rear panel 12 comprises a substantially a planar or flat surface 34, and the rear face of the front panel 14 comprises a substantially planar or flat surface 36. As best shown in FIG. 8, the three panels of the holder 10 are arranged with the intermediate panel 16 between the rear panel 12 and the front panel 14, with the flat surface 22 of the intermediate panel 16 contacting the flat surface 34 of the rear panel 12 and with the other flat surface 24 of the intermediate panel 16 contacting the flat surface 36 of the front panel 14. When the panels 12, 16, 14 are so arranged, there is created a compartment within the holder 10 peripherally defined by the rectangular opening 26 in the intermediate panel 16 and having a depth defined by the space between the two facing surfaces 34, 36 of the rear and front panels 12, 14 equal to the thickness t of the intermediate panel 16.

The three panels 12, 16, 14 are secured together in this arrangement by suitable fasteners. In the preferred embodiment, the intermediate panel 16 includes spaced-apart apertures 38 extending through the intermediate panel 16, preferably adjacent the periphery 28 of the intermediate panel 16, such as four apertures 38 near the four respective corners of the rectangular intermediate panel 16. The rear panel 12 includes apertures 40 which may be blind (as shown in FIG. 5) or which may extend through the rear panel 12, and the front panel 14 includes apertures 42 therethrough. The apertures 40 and the apertures 42 are arranged such that respective ones of the apertures 40 and 42 are aligned with respective ones of the apertures 38 of the first panel 16, for respectively receiving longitudinal fasteners such as screws 44. The apertures 42 may be beveled along the front surface of the front panel 14, for receiving a beveled edge of the head of the screws 44, and the apertures 40 in the rear panel 12 are preferably tapped or threaded for cooperating with the threaded portion of the screws 44, for releasably securing the panels 12, 16, 14 together.

In use, a person may place the intermediate panel 16 upon the rear panel 12 with the surface 22 contacting the surface 34. The user may then position the card 18 within the opening 26 and upon the exposed portion of the surface 34 within the opening 26. The user then places the front panel 14 upon the intermediate panel 16 with the surface 36 in contact with the surface 24 and covering the card 18 situated in the opening 26, with the apertures 42, 38, 40 respectively in alignment. Finally, the user fastenably inserts the screws 44 in the aligned apertures for securing the panels together with the card 18 contained in the compartment thereby created. The card 18 may be removed from the holder 10 by unscrewing and removing the screws 44.

As earlier noted, the thickness t of the intermediate panel 16 is determined by the thickness of the collectible item, and the thickness t may be determined for holding the collectible items 18 through a range of item thicknesses 20. In an example of a holder 10 for containing a collectible card 18, the thickness t of the intermediate panel 16 was approximately 0.100 inch, for holding cards up to 0.100 inch thick including “standard” cards 18 of nominally 0.016 inch thickness. In such example, the width dimension of the rectangular opening 26 was 2.670 inches and the height dimension of the rectangular opening 26 was 3.700 inches, which is appropriate for holding cards of standard peripheral dimensions (nominally 2.5 inches width by 3.5 inches length) with or without such card being further protected by a conventional card sleeve. The outer or peripheral dimensions of the three rectangular panels of this example were 3 9/16 inches in width and 5 11/16 inches in height, the thickness of the rear panel 12 was approximately 9/32 inch and the thickness of the front panel 14 was approximately 3/16 inch.

The intermediate panel 16 may be transparent, either clear or colored, or the intermediate panel 16 may be opaque including an opaque color including metalization. Card holders 10 having intermediate panels of various colors may be useful for categorizing a person's collection of collectible items such as cards or comic books, or for distinguishing one person's collection from the collection of another person.

Several intermediate panels 16 of different thicknesses and/or different size openings 26 and/or of different colors may be interchangeable for use with the same rear and front panels 12, 14.

The three panels may be manufactured by methods conventional in the plastics fabrication art, such as injection molding and/or machining.

A single holder 10 may hold more than one collectible item. For example, the intermediate panel 16′ shown in FIG. 9 contains two side-by-side openings 26′ for holding two collectible items 18 such as sports or game cards. The outer or peripheral dimensions 28′ for the intermediate panel 16′ are greater than the outer or peripheral dimensions 28 of the single-opening intermediate member 26 (FIG. 3), and the peripheral dimensions of the rear and front panels for combination with the dual-opening intermediate panel 16′ corresponds to the peripheral dimensions 28′ of the dual-opening intermediate panel 16′; otherwise, the concepts previously discussed are applicable to such dual-card holder as well as to holders for containing more than two cards.

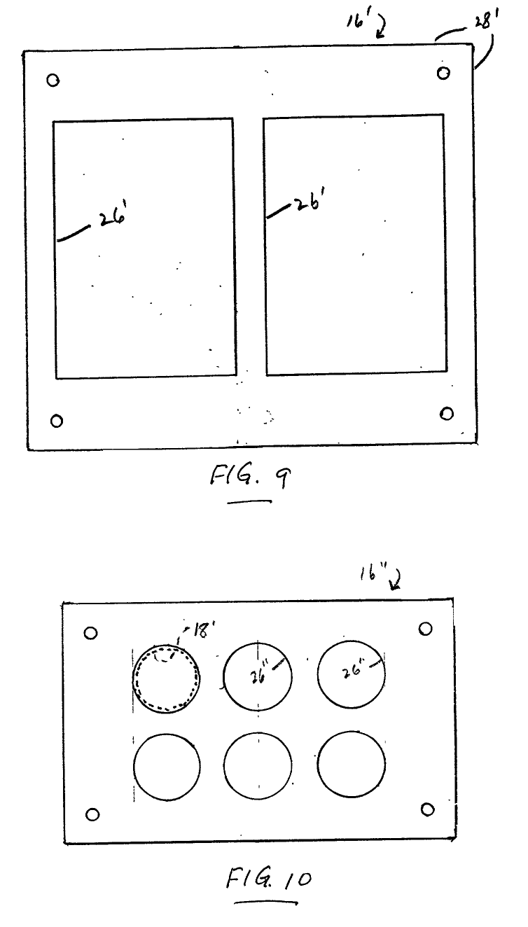

FIG. 10 shows an intermediate holder 16″ having circular openings 26″, for combination with the rear and front panels 12, 14 for holding generally circular collectible items such as coins 18′.

Thus, there have been described preferred embodiments of a protective display holder for collectible items such as cards, photographs, books, and coins. The holder is constructed of three rigid panels secured together with the intermediate panel having an opening therein for containing the collectible item. Other embodiments of the present invention, and variations of the embodiments described herein, may be developed without departing from the essential characteristics thereof. Accordingly, the invention should be limited only by the scope of the claims listed below.

I claim:

1. A protective display holder for at least one item having thickness and peripheral dimensions, the holder comprising the combination of:
a first rigid panel of predetermined thickness between parallel flat surfaces thereof, said predetermined thickness equal to or greater than the thickness of the at least one item, said first panel having at least one opening therethrough of dimensions equal to or greater than the peripheral dimensions of the at least one item, said first panel including spaced-apart apertures therethrough;
a second rigid panel and a third rigid panel, each of said second and third rigid panels including a flat surface and having peripheral dimensions substantially the same as the peripheral dimensions of said first panel, at least one of said second and third panels being transparent;
said panels arranged with said first panel between said second and third panels and with one of said flat surfaces of said first panel contacting said flat surface of said second panel and the other of said flat surfaces of said first panel contacting said flat surface of said third panel, each of said second and third panels including apertures respectively aligned with said apertures of first panel; and
fasteners removably receivable in the aligned apertures for securing said panels together.

2. The holder according to claim 1, wherein:
said fasteners are received in said aligned apertures and secure said panels together.

3. The holder according to claim 1, wherein:
said fasteners are screws having threads, and said apertures included in one of said second and third panels are threaded for cooperating with said threads of said screws.

4. The holder according to claim 1, wherein:
said first panel is opaque.

5. The holder according to claim 1, wherein:
said first panel is transparent.

6. The holder according to claim 1, wherein:
said first panel is colored.

7. The holder according to claim 1, wherein:
the at least one item is of rectangular peripheral dimensions, and said dimensions of said at least one opening of said first panel are rectangular for accommodating the rectangular item.

8. The holder according to claim 7, wherein:
the peripheral dimensions of said first, second and third panels are rectangular.

9. The holder according to claim 7, wherein:
the at least one item is a card.

10. The holder according to claim 7, wherein:
the at least one item is a photograph.

11. The holder according to claim 7, wherein:
the at least one item is a book.

12. The holder according to claim 1, wherein:
the at least one item is a coin, and said at least one opening of said first panel is circular for accommodating the at least one coin.

13. The holder according to claim 1,
including
the at least one item contained within said at least one opening in said first panel and between said flat surfaces of said second and third panels;
and wherein
said fasteners are received in said aligned apertures and secure said panels together.

14. A protective display holder for an item having thickness and peripheral dimensions, the holder comprising the combination of:
a first rigid panel of predetermined thickness between parallel flat surfaces thereof, said predetermined thickness equal to or greater than the thickness of the item, said first panel having an opening therethrough of dimensions equal to or greater than the peripheral dimensions of the item, said first panel including spaced-apart apertures therethrough;
a second rigid panel and a third rigid panel, each of said second and third rigid panels including a flat surface and having peripheral dimensions substantially the same as the peripheral dimensions of said first panel, at least one of said second and third panels being transparent;
said panels arranged with said first panel between said second and third panels and with one of said flat surfaces of said first panel contacting said flat surface of said second panel and the other of said flat surfaces of said first panel contacting said flat surface of said third panel, each of said second and third panels including apertures respectively aligned with said apertures of first panel; and
fasteners removably receivable in the aligned apertures for securing said panels together.

15. The holder according to claim 14, wherein:
said fasteners are received in said aligned apertures and secure said panels together.

16. The holder according to claim 14, wherein:
said fasteners are screws having threads, and said apertures included in one of said second and third panels are threaded for cooperating with said threads of said screws.

17. The holder according to claim 14, wherein:
said first panel is opaque.

18. The holder according to claim 14, wherein:
said first panel is transparent.

19. The holder according to claim 14, wherein:
said first panel is colored.

20. The holder according to claim 14, wherein:
the item is of rectangular peripheral dimensions, and said dimensions of said opening of said first panel are rectangular for accommodating the rectangular item.

21. The holder according to claim 20, wherein:
said peripheral dimensions of said first, second and third panels are rectangular.

22. The holder according to claim 20, wherein:
the item is a card.

23. The holder according to claim 20, wherein:
the item is a photograph.

24. The holder according to claim 20, wherein:
the item is a book.

25. The holder according to claim 14, wherein:
the item is a coin, and said opening of said first panel is circular for accommodating the coin.

26. The holder according to claim 14,
including
the item contained within said opening in said first panel and between said flat surfaces of said second and third panels;
and wherein
said fasteners are received in said aligned apertures and secure said panels together.
